(19) United States
(12) Patent Application Publication
(10) Pub. No.: US 2025/0247401 A1
(43) Pub. Date: Jul. 31, 2025

(54) SECURITY ALERTS ACROSS ORGANIZATIONS

(71) Applicant: Google LLC, Mountain View, CA (US)

(72) Inventor: Anurag Singla, Cupertino, CA (US)

(21) Appl. No.: 18/425,498

(22) Filed: Jan. 29, 2024

(51) Int. Cl. H04L 9/40

(52) U.S. Cl. CPC H04L 63/1416

(57) ABSTRACT

A method includes obtaining a first set of data pertaining to a first alert generated with respect to first malicious activity relating to a first set of computing devices of a first entity. The first set of data includes the first alert, first metadata for first malicious activity associated with the first alert, and first user feedback relating to the first alert and provided by a first user associated with the first entity. The method further includes identifying second malicious activity relating to a second set of computing devices of a second entity, the second malicious activity having second metadata. The method further includes generating a first similarity score based on a comparison of the first metadata and the second metadata and causing a second alert generated with respect to the second malicious activity to be associated with first alert properties defined based on the first user feedback.

### TECHNICAL FIELD

Aspects and implementations of the present disclosure relate to computer security, and in particular to generating alerts related to malicious activity with respect to computing devices.

### BACKGROUND

Computing devices such as data centers and cloud computing platforms may be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Security platforms typically have malicious activity notification mechanisms in place that alert clients when potential malicious activity is detected. The malicious activity can then be mitigated, e.g., by blocking a malicious file from being downloaded, stopping malicious processes that are running, etc. Reviewing and acting on malicious activity alerts is often a manual and time- consuming process for security professionals, which can result in human errors and can strain the human resources of security teams, thereby decreasing the overall effectiveness and threat coverage of the security platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for improved security alerts across organizations. In an implementation, a method includes obtaining a first set of data pertaining to a first alert generated with respect to first malicious activity relating to a first set of computing devices of a first entity. The first set of data includes the first alert, first metadata for first malicious activity associated with the first alert, and first user feedback relating to the first alert and provided by a first user associated with the first entity. The method further includes identifying second malicious activity relating to a second set of computing devices of a second entity. The second malicious activity has second metadata. The method further includes generating a first similarity score based on a comparison of the first metadata for the first malicious activity and the second metadata for the second malicious activity. The method further includes, responsive to the first similarity score satisfying a similarity criterion, causing a second alert generated with respect to the second malicious activity relating to the second set of computing devices of the second entity to be associated with first alert properties defined based on the first user feedback relating to the first alert and provided by the first user associated with the first entity.

In some embodiments, the first alert properties include at least one of a severity value, a priority value, a risk value, a confidence value, or a usefulness value.

In some embodiments, the first alert is associated with second alert properties, the first user feedback relating to the first alert and provided by the first user associated with the first entity includes positive feedback, and at least a first property value of the first alert properties is a higher value than at least a second property value of the second alert properties.

In some embodiments, the first alert is associated with second alert properties, the first user feedback relating to the first alert and provided by the first user associated with the first entity includes negative feedback, and at least a first property value of the first alert properties is a lower value than at least a second property value of the second alert properties.

In some embodiments, the method further includes obtaining second user feedback relating to the second alert and provided by a second user associated with the second entity. The method further includes identifying third malicious activity relating to a third set of computing devices of a third entity. The third malicious activity has third metadata. The method further includes generating a second similarity score based on a comparison of the first metadata for the first malicious activity, the second metadata for the second malicious activity, and the third metadata for the third malicious activity. The method further includes, responsive to the second similarity score satisfying the similarity criterion, causing a third alert generated with respect to the third malicious activity relating to the third set of computing devices of the third entity to be associated with second alert properties defined based on a combination of the first user feedback relating to the first alert and provided by the first user associated with the first entity and the second user feedback relating to the second alert and provided by the second user associated with the second entity.

In some embodiments, the first entity is part of a first entity group and the second entity is part of the first entity group.

In some embodiments, generating the first similarity score includes applying a machine learning model to the first metadata for the first malicious activity to obtain a first encoding. Generating the first similarity score further includes applying the machine learning model to the second metadata for the second malicious activity to obtain a second encoding. Generating the first similarity score further includes computing a distance between the first encoding and the second encoding, the distance representing the first similarity score.

In some embodiments, generating the first similarity score includes calculating a first distance between a first data of the first metadata for the first malicious activity and a second data of the second metadata for the second malicious activity. Generating the first similarity score further includes calculating a second distance between a third data of the first metadata for the first malicious activity and a fourth data of the second metadata for the second malicious activity. Generating the first similarity score further includes combining the first distance and the second distance to obtain a third distance, the third distance representing the first similarity score.

In some embodiments, the combining the first distance and the second distance includes at least one of calculating a sum of the first distance and the second distance, calculating a max value of the first distance and the second distance, calculating an average of the first distance and the second distance, or calculating a linear combination of the first distance and the second distance.

In some embodiments, causing the second alert generated with respect to the second malicious activity relating to the second set of computing devices of the second entity to be associated with first alert properties defined based on the first user feedback relating to the first alert and provided by the first user associated with the first entity results in the second alert being suppressed.

In some embodiments, the method further includes identifying third malicious activity relating to a third set of computing devices of a third entity. The third malicious activity has third metadata. The method further includes generating a second similarity score based on a comparison of the first metadata for the first malicious activity and the third metadata for the third malicious activity. The method further includes, responsive to the second similarity score satisfying the similarity criterion, causing a third alert generating with respect to the third malicious activity relating to the third set of computing devices of the third entity to be associated with second alert properties based on the first user feedback relating to the first alert and provided by the first user associated with the first entity and with third alert properties defined based on the third malicious activity.

In some embodiments a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments a system comprises: a memory device; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for improved security alerts across organizations, in accordance with at least one embodiment.

FIG. 2 depicts an example clustering of organizations, in accordance with at least one embodiment.

FIG. 3 depicts a flow diagram of an example method of generating improved security alerts across organizations, in accordance with at least one embodiment.

FIG. 4 is a block diagram illustrating an exemplary computer system, in accordance with at least one embodiment of the present disclosure.

### DETAILED DESCRIPTION

Threat indicators may indicate past or current malicious activities with respect to computing resources. Computing resources may include, for example, servers, data centers, and cloud computing resources. Various computing resources may be susceptible to malicious activity. Examples of malicious activity include installation or operation of malware (e.g., malicious software), accessing or attempting to access computing resources without permission or authorization, modifying or exfiltrating data stored on computing resources without permission or authorization, exhausting computing resources (e.g., a denial-of-service attack), and other forms of unwanted activity. Malicious activity is often problematic for owners and operators of computing resources because the malicious activity can lead to interruption or inefficient operation of computing resources, or in extreme cases, substantial financial loss and liabilities. Malware is used herein as an example of malicious activity, but malicious activity often involves many other components such as those mentioned above, which are also within the scope of the present disclosure.

A security platform may provide services for detecting malicious activity with respect to computing resources, enabling timely mitigation before the malicious activity causes significant harm. For example, a security platform may receive data from computing resources (e.g., system event logs or new files inbound from a network connection) and analyze the data for signs of malicious activity. Detection rules may associate patterns in the data with different types of malicious activity, and rule evaluation engines may evaluate rules on new data. Upon evaluating a rule and detecting potential malicious activity, the security platform can issue an alert to the computing resources (e.g., via an application programming interface (API)) or to the owners and operators of the computing resources (e.g., via email). The malicious activity can then be automatically or manually mitigated in a timely manner, such as by blocking a malicious file from being downloaded, stopping malicious processes that are running, etc. Security information and event management (SIEM) systems are examples of security platforms and may include software, hardware, and managed service components.

In conventional security platforms, security professionals (e.g., security analysts, security engineers, threat intelligence operators) can struggle with being overloaded with threat data. Oftentimes the security platform will issue too many alerts, overwhelming the security professionals and preventing them from being able to timely respond to the most urgent malicious activities, resulting in needless consumption of computing resources and possible financial losses. In some cases, the alert might have accurate data (e.g., a valid internet protocol (IP) address) but the alert might not require any action from a security professional (e.g., non-malicious communication with a web server). In other cases, an alert with the same data (e.g., same IP address) might require immediate action (e.g., sending malicious exploitation traffic to a vulnerable service). It is difficult to manually review or build automated workflows to investigate and respond to these noisy alerts.

Aspects of the present disclosure address the above and other deficiencies by providing frameworks for generating improved security alerts across organizations. For example, a security platform such as a SIEM system may generate alerts with properties (e.g., severity, priority, risk, confidence, usefulness, etc.) based on user feedback related to similar alerts. In some embodiments, attributes of new alerts for a first entity (e.g., first organization) may be determined based on feedback from users of a second, similar entity (e.g., second organization). For example, each organization may be assigned to one or more groups based on characteristics of the alerts the organization receives (e.g., alert types, event file paths, event timestamps, etc.) and based on characteristics of the organization itself (e.g., industry vertical, size, revenue, country, etc.).

A security analyst of a first organization may close (e.g., dismiss, resolve, address, etc.) an alert and may provide feedback regarding whether the alert was useful (e.g., whether the security analyst needed to act on the alert, whether the alert should not have been raised in the first place, whether the properties of the alert were accurate, etc.) and/or whether the activity that triggered the alert was malicious. If the alert was useful and/or the activity that triggered the alert was malicious, when a second organization receives a similar alert, the security platform can label the similar alert with attributes indicating increased severity (e.g., a higher severity score, a higher risk level, a higher confidence, etc.). If the alert was not useful and/or the activity that triggered the alert was not malicious, when a second organization receives a similar alert, the security platform can label the similar alert with attributes indicating reduced severity (e.g., a lower severity score, a lower risk level, a lower confidence, etc.). Thus, over time, the security platform may generate more useful alerts across organizations based on a combination of user feedback from across the organizations.

Advantages of the disclosed embodiments over the existing technology include but are not limited to improved accuracy and efficiency when generating alerts for malicious activity with respect to computing devices. Modifying alert properties based on user feedback across organizations, may provide improved threat coverage while reducing false positives. Thus, a security platform may experience reduced operating costs and improved performance including improved latency and throughput, which may benefit clients as well as increase trust in the security platform.

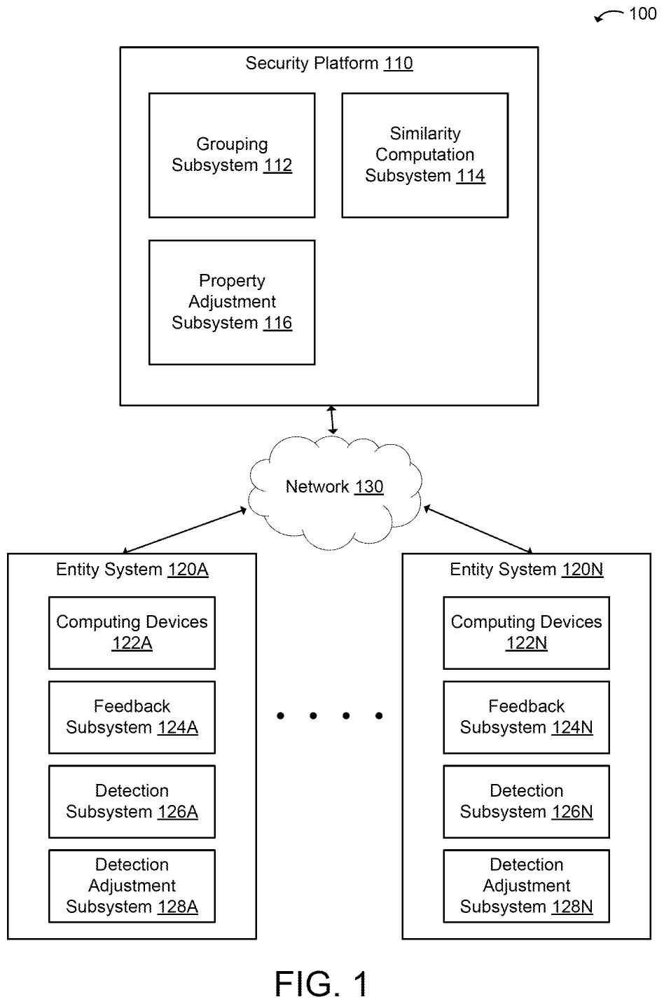

FIG. 1 illustrates an example system 100 for improved security alerts across organizations, in accordance with at least one embodiment. System 100 may include security platform 110 and one or more entity systems 120A-N connected to network 130, such as a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Security platform 110 can provide services for providing security alerts with respect to computing resources of entity systems 120A-120N. Security platform 110 may include grouping subsystem 112 for clustering entities (e.g., organizations) and/or the computing resources and devices of an entity (e.g., an organization), similarity computation subsystem 114 for determining how similar two or more alerts and/or malicious activities are to one another, and property adjustment subsystem 116 for adjusting the properties of an alert based on user feedback. For example, grouping subsystem 112 may receive one or more properties associated with an organization (e.g., from entity system 120A-N). The one or more properties may include dynamic properties and static (or mostly static) properties. For example, dynamic properties may include the number of alerts generated for (or by) an organization, the number of detected malicious events, indicators of compromise (IoCs) associated with the organization, and the like. Dynamic properties may also be based on interactions of computing devices of the organization with external entities, such as domains, universal resource locators (URLs), files, internet protocol (IP) addresses, email addresses, cloud resource geo-locations, applications, and the like.

Static properties may include the industry vertical of an organization, the size of the organization, the revenue of the organization, the country where computing devices of the organization are located, etc. Static properties may also include characteristics of data provided to security platform 110, such as type of data sources, number of users that interact with security platform 110, number of devices providing data to security platform 110, and the like. Based on the dynamic and static properties of each entity (e.g., organization), an entity may be assigned to an entity group or cluster. An entity may be assigned to more than one group/cluster at a time. In some embodiments, entities are clustered using a clustering algorithm such as k-means clustering, BIRCH algorithm, gaussian mixture model algorithm, and/or the like.

In some embodiments, entities may be periodically regrouped. For example, between a first clustering event and a second clustering event, an organization may increase (or decrease) in size, revenue, number of devices, etc. and may be assigned to one or more different groups after being regrouped.

Similarity computation subsystem 114 may calculate similarity scores between alerts. For example, a first alert may have associated first properties and a second alert may have associated second properties. The alert properties may be based on one or more characteristics of the malicious activity associated with the alert. For example, the alert properties may include multiple fields, including an event timestamp, an event type, a target of the malicious activity, a file path, a URL, a severity, etc. Alerts may be considered similar if the distance between one or more metadata fields satisfies a similarity threshold criterion (e.g., a distance less than 5, 10, 20, etc.). Some distances may be calculated based on the absolute value of subtraction of numerical fields. Some distances (e.g., for fields with text values) may be calculated based on the minimum number of single-character edits (e.g., insertions, deletions, substitutions) required to change one word into the other (e.g., Levenshtein distance). Some distances may be calculated based on a comparison of one or more substrings of the field (e.g., filename, file extension, complete file path, etc.).

In some embodiments, a neural network (e.g., an auto encoder) may convert an alert (or alert properties) into an encoding within an embedding space. A distance between a first alert and a second alert may be calculated by computing a distance between a first encoding corresponding to the first alert properties and a second encoding corresponding to the second alert properties.

The distance between the one or more fields of the alerts may be combined to obtain a similarity score. The distances may be combined by calculating a sum of the distances (e.g., a sum of a first distance and a second distance), by calculating a max value of the distances, by calculating an average of the distances, or by calculating a linear combination of the distances. For example, each field may have an associated weight that is combined with (e.g., multiplied) the field distance when calculating the combined distance. In some embodiments, distances are normalized, and the final distance is the root mean square of individual distances per field. In some embodiments, an alternative distance calculation is used, such as Jaro distance, longest common sequence distance, cosine distance, Euclidean distance, and the like.

Property adjustment subsystem 116 may modify the properties of an alert based on user feedback. For example, if a first alert receives positive feedback (e.g., from a user of a first entity) indicating that the alert was helpful and/or relevant, when a similar alert (as determined by similarity computation subsystem 114) is generated (e.g., for computing devices of a second entity), one or more values of one or more properties of the similar alert may be increased (e.g., a higher severity score, a higher confidence, a higher risk level, etc.). If the first alert receives negative feedback (e.g., from a user of a first entity) indicating that the alert was not helpful and/or relevant, when a similar alert (as determined by similarity computation subsystem 114) is generated (e.g., for computing devices of a second entity), one or more values of one or more properties of the similar alert may be reduced (e.g., a lower severity score, a lower confidence, a lower risk level, etc.). In some embodiments, the properties of an alert may only be modified based on user feedback of a user of an entity that is in a same entity group as the entity for which the alert is generated.

For example, a first entity and a third entity may be in a first entity group and a second entity may be in a second entity group. If a user of the first entity provides positive feedback to an alert and a user of the second entity provides negative feedback to a similar alert, an alert similar to the two alerts generated for the third entity may have increased attribute values because of the positive feedback from the user of the first entity, which is in the same entity group as the third entity.

In some embodiments, to prevent feedback loops that continuously increase (or decrease) the attribute values of an alert that occurs multiple times, property adjustment subsystem 116 may probabilistically (e.g., on a random basis) not adjust the attributes of an alert even if it is similar to another alert that has received user feedback.

In some embodiments, an entity may be included in multiple entity groups and each entity group may have alerts with user feedback that are similar to an alert generated for the entity. Thus, property adjustment subsystem 116 may combine the property adjustments from each entity group to determine how to adjust the alert properties of the given alert. For example, property adjustment subsystem 116 may calculate an average value for an alert property based on the adjusted properties of alerts from each of the entity groups. As an example, an organization may be part of a first cluster (e.g., entity group), a second cluster, and a third cluster. Property adjustment subsystem 116 may need to (e.g., based on similarity scores between alerts in the first cluster, second cluster, and third cluster) adjust the risk score of an alert. If the first cluster suggests a risk score of 80, the second cluster suggests a risk score of 55, and the third cluster suggests a risk score of 57, the final risk score for the alert may be a combination of each of the scores. In some embodiments, the final risk score may be based on a minimum of the values, a maximum of the values, an average of the values, a mode of the values, etc. If, for example, the final risk score were based on an average of the values, property adjustment subsystem 116 may assign a risk score of 64 ((80+55+57)/3) to metadata associated with the alert.

In some embodiments, an alert may be associated with multiple sets of alert properties. For example, an alert may have one or more historical properties that may show how the values of the alert properties have changed over time. For example, an alert may have a first set of alert properties based on the malicious activity associated with the event. If property adjustment subsystem 116 modifies the property values, the old property values may become historical property values and the new, modified property values may become the current property values associated with the alert. In some embodiments, suggested property values from each cluster an entity is part of may be included as historical property values. In some embodiments, property adjustment subsystem 116 may modify the property values by directly adding historical property values instead of modifying the current property values (e.g., to prevent property values from increasing in a feedback loop).

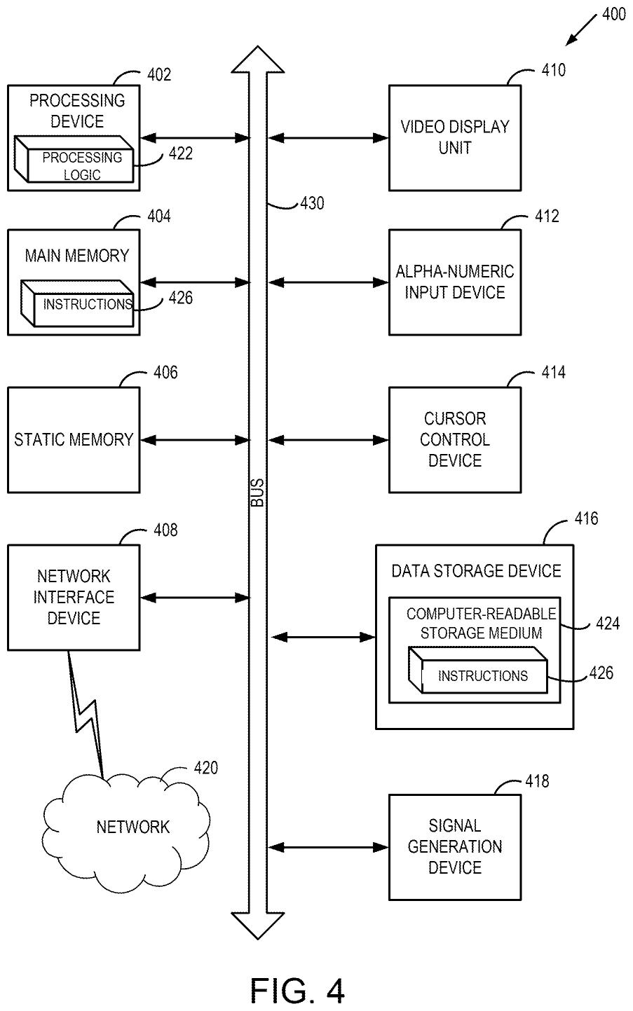

Entity systems 120A-N may each include computing resources of an entity (e.g., an organization) such as computing devices 122A-N, feedback subsystems 124A-N, detection subsystems 126A-N, and detection adjustment subsystems 128A-N. Computing devices 122A-N may include one or more processing devices, volatile and non-volatile memory, data storage, one or more input/output peripherals such as network interfaces. FIG. 4 illustrates an example architecture of computing devices. In some embodiments, computing devices 122A-N may be singular devices such as smartphones, tablets, laptops, desktops, workstations, edge devices, embedded devices, servers, network appliances, security appliances, etc. In some embodiments, computing devices 122A-N may comprise multiple devices of similar or varying architecture such as computing clusters, data centers, co-located servers, enterprise networks, geographically disparate devices connected via virtual private networks (VPNs), etc. In some embodiments, computing devices 122A-N may comprise hardware devices such as those just described, virtual resources such as virtual machines (VMs) and containerized applications, or a combination of hardware and virtual resources.

In some embodiments, entity systems 120A-N is part of an entity's data center that includes computing devices 122A-N. Any or all of feedback subsystems 124A-N, detection subsystems 126A-N, and detection adjustment subsystems 128A-N can be either part of the entity's data center or be located outside of the entity's data center (e.g., in a cloud computing environment). In other embodiments, entity systems 120A-N is a part of a cloud computing environment having computing devices 122A-N assigned to the entity, and including feedback subsystems 124A-N, detection subsystems 126A-N, and detection adjustment subsystems 128A-N.

Feedback subsystems 124A-N may collect user feedback related to alerts associated with a particular entity/organization. For example, a security analyst may receive an alert (e.g., an alert generated by security platform 110, an alert generated by entity system 120A) and may perform one or more operations in response to the alert. After finishing the one or more operations, the security analyst may provide feedback (e.g., to security platform 110 via feedback subsystem 124A) regarding whether the alert was useful and/or whether the activity that triggered the alert was malicious. The user feedback may be provided to security platform 110 and may be used to modify alert properties of future alerts.

Detection subsystems 126A-N may include one or more detection rules and/or detection models trained to identify malicious activity. Detection subsystems 126A-N may read system logs and/or other data sources (e.g., event logs) to identify potential malicious activity. System and/or event logs may include data (e.g., telemetry data) generated by computing devices 122A-N and/or corresponding software during execution regarding metrics, measurements, events, etc. pertaining to computing devices 122A-N and/or corresponding software. Upon detecting malicious activity, detection subsystems 126A-N may generate an alert based on the configured detection rule and/or detection model that identified the malicious activity, and/or may store data identifying the detected malicious activity and/or properties of the alert in a datastore. In some embodiments, detection subsystems 126A-N are part of entity systems 120A-N and have access to event logs of entity systems 120A-N. In some embodiments, entity systems 120A-N provide event logs to security platform 110 and detection subsystems 126A-N are part of security platform 110.

Detection adjustment subsystems 128A-N may modify one or more detection rules and/or detection models of detection subsystems 126A-N based on user feedback (e.g., from feedback subsystems 124A-N, from other organizations via security platform 110, etc.). For example, if a particular detection rule is used to generate an alert with a first set of alert properties and user feedback indicates that the alert properties should have higher (or lower) values, the detection rule may be modified to generate the alert with higher (or lower) property values instead of relying on property adjustment subsystem 116 to adjust the alert properties after the alert has been generated. In some embodiments, detection adjustment subsystems 128A-N may only modify a detection rule and/or detection model after receiving user feedback that exceeds a modification threshold. For example, in some embodiments, detection adjustment subsystems 128A-N may only modify a detection rule and/or detection model after receiving 10 (50, 100, 1000) instances of positive (or negative) user feedback. In some embodiments, the amount of user feedback necessary to modify a detection rule and/or detection model may be determined based on the organization, the cluster(s) the organization is in, and/or other properties. In some embodiments, a detection rule and/or detection model may be disabled if user feedback indicates that the alerts generated by the detection rule and/or detection model do not require mitigation activities (e.g., a benign alert). In some embodiments, the user feedback may be included as part of a dataset used for supervised training of one or more detection models.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether security platform 110 and entity systems 120A-N collect user information (e.g., information about a user's social network, social actions or activities, profession, a user's preferences, or a user's current location), or to control whether and/or how to receive content from the security platform 110 and entity systems 120A-N that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the security platform 110 and entity systems 120A-N.

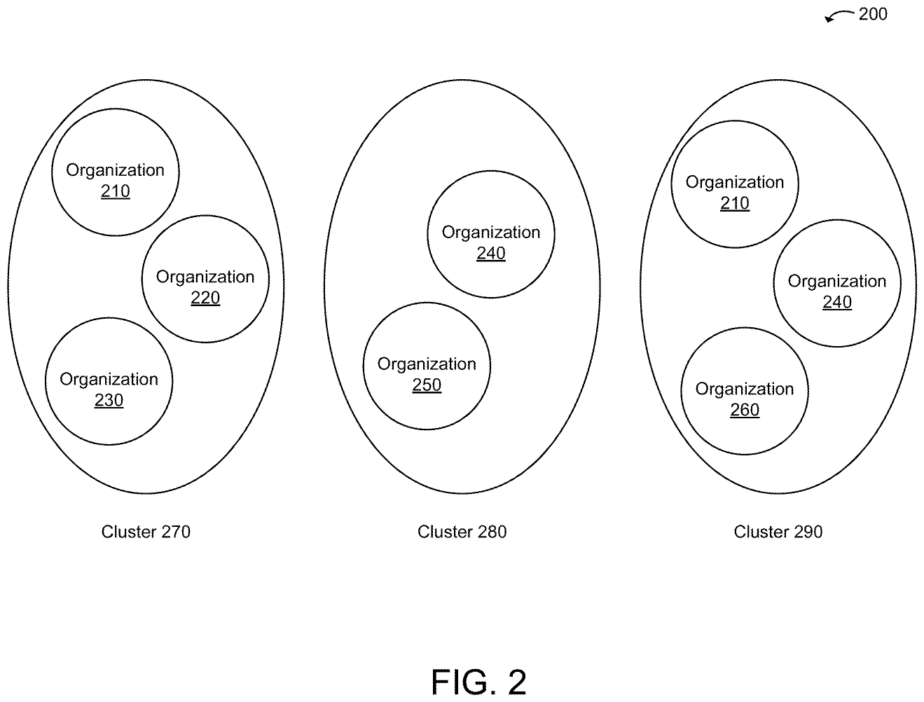

FIG. 2 depicts an example clustering 200 of organizations 210-260, in accordance with at least one embodiment. Clustering 200 may include three clusters: cluster 270, cluster 280, and cluster 290. In some embodiments, cluster 270 may cluster organizations (entities) based on one or more shared dynamic properties. For example, organization 210, organization 220, and organization 230 may receive (or generate) similar alerts (e.g., as determined by similarity computation subsystem 140 of FIG. 1) and may be included in the same cluster. Organization 240 may receive (or generate) alerts similar to those of organization 250 and may not receive (or generate) alerts similar to those of organization 210, organization 220, or organization 230. Thus, organization 240 and organization 250 may be in cluster 280 and not in cluster 270. In some embodiments, cluster 290 may group organizations based on one or more static properties. For example, organization 210, organization 240, and organization 260 may have the same industry vertical, same amount of revenue, same number of users and/or devices, etc., and therefore may be grouped into the same cluster. Although organization 210 and organization 240 are in different dynamic clusters (cluster 270 and cluster 280, respectively), they may be in the same static cluster (cluster 290).

In some embodiments, organizations are clustered using k-means clustering. In some embodiments, BIRCH clustering algorithm is used. In some embodiments, gaussian mixture model clustering algorithm is used. In some embodiments, another clustering algorithm is used. In some embodiments, clustering is repeated periodically (e.g., on a fixed schedule, on demand, in response to a triggering event, etc.) such that the clusters a particular organization belongs to may change over time.

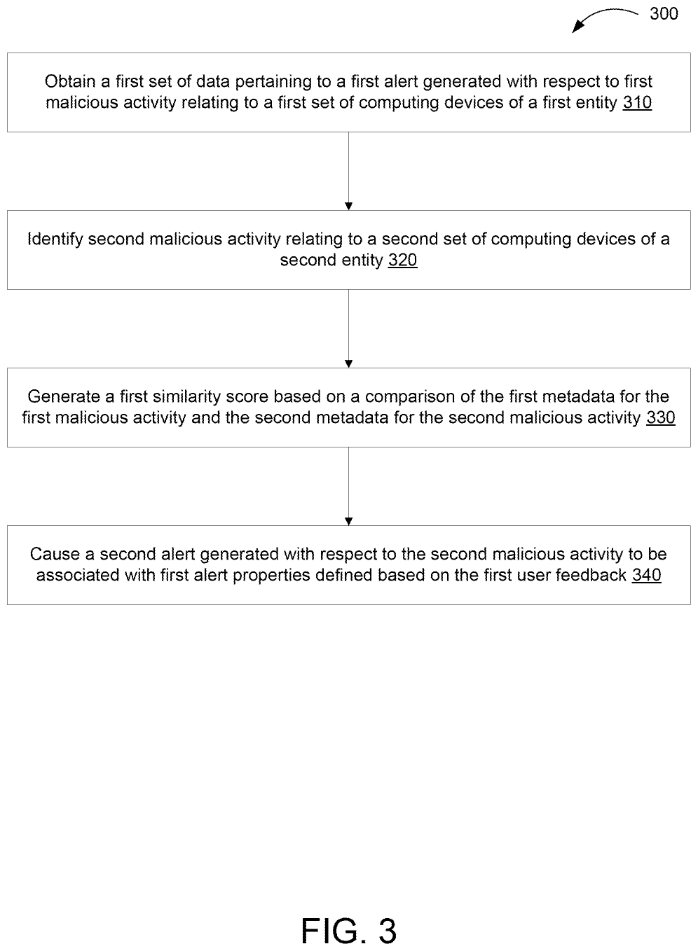

FIG. 3 depicts a flow diagram of an example method 300 of generating improved security alerts across organizations, in accordance with at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of system 100 for improved security alerts across organizations of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 310, processing logic may obtain a first set of data pertaining to a first alert generated with respect to first malicious activity relating to a first set of computing devices of a first entity. The first set of data may include the first alert, first metadata for the first malicious activity associated with the first alert, and first user feedback relating to the first alert and provided by a first user associated with the first entity.

At block 320, processing logic may identify second malicious activity relating to a second set of computing resources of a second entity. The second malicious activity may have second metadata. In some embodiments, the first entity is part of a first entity group (e.g., cluster) and the second entity is part of the first entity group. In some embodiments, the first entity is part of a first entity group and the second entity is part of a second entity group.

At block 330, processing logic may generate a first similarity score based on a comparison of the first metadata for the first malicious activity and the second metadata for the second malicious activity. In some embodiments, to generate the first similarity score, processing logic may apply a machine learning model to the first metadata for the first malicious activity to obtain a first encoding. Processing logic may further apply the machine learning model to the second metadata for the second malicious activity to obtain a second encoding. Processing logic may further compute a distance between the first encoding and the second encoding, the distance representing the first similarity score.

In some embodiments, the machine learning model may include one or more artificial neural networks (also referred to simply as a neural network). The artificial neural network can include a feature representation component with a classifier or regression layers that map features to a target output space. The artificial neural network may be, for example, a convolutional neural network (CNN) that can include a feature representation component with a classifier or regression layers that map features to a target output space, and can host multiple layers of convolutional filters. Pooling can be performed, and non-linearities may be addressed, at lower layers, on top of which a multi-layer perceptron can be commonly appended, mapping top layer features extracted by the convolutional layers to decisions (e.g., classification outputs). The neural network may further be a deep network with multiple hidden layers or a shallow network with zero or a few (e.g., 1-2) hidden layers. Deep learning may use a cascade of multiple layers of nonlinear processing units for feature extraction and transformation. Each successive layer can use the output from the previous layer as input. In deep learning, each level learns to transform its input data into a slightly more abstract and composite representation. In some embodiments, the artificial neural network may be an autoencoder that compresses the input into a lower-dimensional representation and reconstructs the output from this representation. The autoencoder may be trained in an unsupervised manner using backpropagation based on training and/or test datasets. For example, the autoencoder may be trained using a training dataset comprising a plurality of malicious activities with their corresponding metadata values.

In some embodiments, to generate the first similarity score, processing logic may calculate a first distance between a first data of the first metadata for the first malicious activity and a second data of the second metadata for the second malicious activity. Processing logic may further calculate a second distance between a third data of the first metadata for the first malicious activity and a fourth data of the second metadata for the second malicious activity. Processing logic may further combine the first distance and the second distance to obtain a third distance, the third distance representing the first similarity score.

In some embodiments, to combine the first distance and the second distance, processing logic may perform at least one of the following: calculate a sum of the first distance and the second distance, calculate a max value of the first distance and the second distance, calculate an average of the first distance and the second distance, or calculate a linear combination of the first distance and the second distance.

At block 340, processing logic may, responsive to the first similarity score satisfying a similarity criterion, cause a second alert generated with respect to the second malicious activity relating to the second set of computing devices of the second entity to be associated with first alert properties defined based on the first user feedback relating to the first alert and provided by the first user associated with the first entity. In some embodiments, the first alert properties include at least one of a severity value, a priority value, a risk value, a confidence value, or a usefulness value. In some embodiments, causing the second alert generated with respect to the second malicious activity relating to the second set of computing devices of the second entity to be associated with the first alert properties defined based on the first user feedback relating to the first alert and provided by the first user associated with the first entity results in the second alert being suppressed. For example, the second alert may not be presented to a user.

In some embodiments, the first alert is associated with second alert properties, the first user feedback relating to the first alert and provided by the first user associated with the first entity includes positive feedback, and at least a first property value of the first alert properties is higher than at least a second property value of the second alert properties. In some embodiments, the first alert is associated with second alert properties, the first user feedback relating to the first alert and provided by the first user associated with the first entity includes negative feedback, and at least a first property value of the first alert properties is lower than at least a second property value of the second alert properties.

In some embodiments, processing logic performing method 300 may further obtain second user feedback relating to the second alert and provided by a second user associated with the second entity. Processing logic may further identify third malicious activity relating to a third set of computing devices of a third entity. The third malicious activity may have third metadata. Processing logic may further generate a second similarity score based on a comparison of the first metadata for the first malicious activity, the second metadata for the second malicious activity, and the third metadata for the third malicious activity. Processing logic may further, responsive to the second similarity score satisfying the similarity criterion, causing a third alert generated with respect to the third malicious activity relating to the third set of computing devices of the third entity to be associated with second alert properties defined based on a combination of the first user feedback relating to the first alert and provided by the first user associated with the first entity and the second user feedback relating to the second alert and provided by the second user associated with the second entity.

In some embodiments, processing logic performing method 300 may further identify third malicious activity relating to a third set of computing devices of a third entity. The third malicious activity may have third metadata. Processing logic may further generate a second similarity score based on a comparison of the first metadata for the first malicious activity and the third metadata for the third malicious activity. Processing logic may further, responsive to the second similarity score satisfying the similarity criterion, cause a third alert generated with respect to the third malicious activity relating to the third set of computing devices of the third entity to be associated with second alert properties defined based on the first user feedback relating to the first alert and provided by the first user associated with the first entity and with third alert properties defined based on the third malicious activity. For example, alert properties based on user feedback may be associated with the second alert, but the alert properties may be included as historical properties of the alert. The alert may have as current alert properties alert properties based on the malicious activity associated with the alert. The current alert properties may be the alert properties that would have been associated with the alert if no user feedback was taken into consideration. In some embodiments, alerts that have alert properties based on user feedback associated as historical properties of the alert may be selected randomly.

FIG. 4 is a block diagram illustrating an exemplary computer system, in accordance with at least one embodiment of the present disclosure. The computer system 400 can correspond to security platform 110, organization 120A-N and/or computing devices 122A-N, described with respect to FIG. 1. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 430.

Processor (processing device) 402 represents one or more general-purpose processing devices such as a microprocessor, central processing unit, or the like, and may include processing logic 422. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for generating improved security alerts across organizations) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker). In some embodiments, computer system 400 may not include video display unit 410, input device 412, and/or cursor control device 414 (e.g., in a headless configuration).

The data storage device 416 can include a non-transitory machine-readable storage medium 424 (also computer-readable storage medium) on which is stored one or more sets of instructions 426 (e.g., for generating improved security alerts across organizations) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for generating improved security alerts across organizations. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub- components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining a first set of data pertaining to a first alert generated with respect to first malicious activity relating to a first set of computing devices of a first entity, the first set of data comprising:
the first alert;
first metadata for first malicious activity associated with the first alert; and
first user feedback relating to the first alert and provided by a first user associated with the first entity; and
identifying second malicious activity relating to a second set of computing devices of a second entity, the second malicious activity having second metadata;
generating a first similarity score based on a comparison of the first metadata for the first malicious activity and the second metadata for the second malicious activity; and
responsive to the first similarity score satisfying a similarity criterion, causing a second alert generated with respect to the second malicious activity relating to the second set of computing devices of the second entity to be associated with first alert properties defined based on the first user feedback relating to the first alert and provided by the first user associated with the first entity.

2. The method of claim 1, wherein the first alert properties comprise at least one of:
a severity value;
a priority value;
a risk value;
a confidence value; or
a usefulness value.

3. The method of claim 1, wherein:
the first alert is associated with second alert properties;
the first user feedback relating to the first alert and provided by the first user associated with the first entity comprises positive feedback; and
at least a first property of the first alert properties has a higher value than at least a second property of the second alert properties.

4. The method of claim 1, wherein:
the first alert is associated with second alert properties;
the first user feedback relating to the first alert and provided by the first user associated with the first entity comprises negative feedback; and
at least a first property of the first alert properties has a lower value than at least a second property of the second alert properties.

5. The method of claim 1, further comprising:
obtaining second user feedback relating to the second alert and provided by a second user associated with the second entity;
identifying third malicious activity relating to a third set of computing devices of a third entity, the third malicious activity having third metadata;
generating a second similarity score based on a comparison of the first metadata for the first malicious activity, the second metadata for the second malicious activity, and the third metadata for the third malicious activity; and
responsive to the second similarity score satisfying the similarity criterion, causing a third alert generated with respect to the third malicious activity relating to the third set of computing devices of the third entity to be associated with second alert properties defined based on a combination of the first user feedback relating to the first alert and provided by the first user associated with the first entity and the second user feedback relating to the second alert and provided by the second user associated with the second entity.

6. The method of claim 1, wherein the first entity is part of a first entity group and the second entity is part of the first entity group.

7. The method of claim 1, wherein generating the first similarity score comprises:
applying a machine learning model to the first metadata for the first malicious activity to obtain a first encoding;
applying the machine learning model to the second metadata for the second malicious activity to obtain a second encoding; and
computing a distance between the first encoding and the second encoding, the distance representing the first similarity score.

8. The method of claim 1, wherein generating the first similarity score comprises:
calculating a first distance between a first data of the first metadata for the first malicious activity and a second data of the second metadata for the second malicious activity;
calculating a second distance between a third data of the first metadata for the first malicious activity and a fourth data of the second metadata for the second malicious activity; and
combining the first distance and the second distance to obtain a third distance, the third distance representing the first similarity score.

9. The method of claim 8, wherein the combining the first distance and the second distance comprises at least one of:
calculating a sum of the first distance and the second distance;
calculating a max value of the first distance and the second distance;
calculating an average of the first distance and the second distance; or
calculating a linear combination of the first distance and the second distance.

10. The method of claim 1, wherein causing the second alert generated with respect to the second malicious activity relating to the second set of computing devices of the second entity to be associated with first alert properties defined based on the first user feedback relating to the first alert and provided by the first user associated with the first entity results in the second alert being suppressed.

11. The method of claim 1, further comprising:
identifying third malicious activity relating to a third set of computing devices of a third entity, the third malicious activity having third metadata;
generating a second similarity score based on a comparison of the first metadata for the first malicious activity and the third metadata for the third malicious activity; and
responsive to the second similarity score satisfying the similarity criterion, causing a third alert generated with respect to the third malicious activity relating to the third set of computing devices of the third entity to be associated with second alert properties defined based on the first user feedback relating to the first alert and provided by the first user associated with the first entity and with third alert properties defined based on the third malicious activity.

12. A system comprising:
a memory device; and
a processing device coupled to the memory device, the processing device to perform operations comprising:
obtaining a first set of data pertaining to a first alert generated with respect to first malicious activity relating to a first set of computing devices of a first entity, the first set of data comprising:
the first alert;
first metadata for first malicious activity associated with the first alert; and
first user feedback relating to the first alert and provided by a first user associated with the first entity; and
identifying second malicious activity relating to a second set of computing devices of a second entity, the second malicious activity having second metadata;
generating a first similarity score based on a comparison of the first metadata for the first malicious activity and the second metadata for the second malicious activity; and
responsive to the first similarity score satisfying a similarity criterion, causing a second alert generated with respect to the second malicious activity relating to the second set of computing devices of the second entity to be associated with first alert properties defined based on the first user feedback relating to the first alert and provided by the first user associated with the first entity.

13. The system of claim 12, wherein the first alert properties comprise at least one of:
a severity value;
a priority value;
a risk value;
a confidence value; or
a usefulness value.

14. The system of claim 12, wherein:
the first alert is associated with second alert properties;
the first user feedback relating to the first alert and provided by the first user associated with the first entity comprises positive feedback; and
at least a first property of the first alert properties is higher than at least a second property of the second alert properties.

15. The system of claim 12, wherein:
the first alert is associated with second alert properties;
the first user feedback relating to the first alert and provided by the first user associated with the first entity comprises negative feedback; and
at least a first property of the first alert properties is lower than at least a second property of the second alert properties.

16. The system of claim 12, further comprising:
obtaining second user feedback relating to the second alert and provided by a second user associated with the second entity;
identifying third malicious activity relating to a third set of computing devices of a third entity, the third malicious activity having third metadata;
generating a second similarity score based on a comparison of the first metadata for the first malicious activity, the second metadata for the second malicious activity, and the third metadata for the third malicious activity; and
responsive to the second similarity score satisfying the similarity criterion, causing a third alert generated with respect to the third malicious activity relating to the third set of computing devices of the third entity to be associated with second alert properties defined based on a combination of the first user feedback relating to the first alert and provided by the first user associated with the first entity and the second user feedback relating to the second alert and provided by the second user associated with the second entity.

17. The system of claim 12, wherein the first entity is part of a first entity group and the second entity is part of the first entity group.

18. The system of claim 12, wherein generating the first similarity score comprises:
applying a machine learning model to the first metadata for the first malicious activity to obtain a first encoding;
applying the machine learning model to the second metadata for the second malicious activity to obtain a second encoding; and
computing a distance between the first encoding and the second encoding, the distance representing the first similarity score.

19. The system of claim 12, wherein generating the first similarity score comprises:
calculating a first distance between a first data of the first metadata for the first malicious activity and a second data of the second metadata for the second malicious activity;
calculating a second distance between a third data of the first metadata for the first malicious activity and a fourth data of the second metadata for the second malicious activity; and
combining the first distance and the second distance to obtain a third distance, the third distance representing the first similarity score.

20. A non-transitory computer-readable storage medium comprising instruction that, when executed by a processing device, cause the processing device to perform operations comprising:
obtaining a first set of data pertaining to a first alert generated with respect to first malicious activity relating to a first set of computing devices of a first entity, the first set of data comprising:
the first alert;
first metadata for first malicious activity associated with the first alert; and
first user feedback relating to the first alert and provided by a first user associated with the first entity; and
identifying second malicious activity relating to a second set of computing devices of a second entity, the second malicious activity having second metadata;
generating a first similarity score based on a comparison of the first metadata for the first malicious activity and the second metadata for the second malicious activity; and
responsive to the first similarity score satisfying a similarity criterion, causing a second alert generated with respect to the second malicious activity relating to the second set of computing devices of the second entity to be associated with first alert properties defined based on the first user feedback relating to the first alert and provided by the first user associated with the first entity.
